(19) United States
(12) Patent Application Publication
(10) Pub. No.: US 2026/0352381 A1
(43) Pub. Date: Nov. 5, 2026

(54) STEP SIZE IDENTIFICATION FOR HYBRID AUTOMATIC REPEAT REQUEST RETRANSMISSIONS

(71) Applicant: QUALCOMM Incorporated, San Diego, CA (US)

(72) Inventors: Morteza SOLTANI, San Diego, CA (US); Jing SUN, San Diego, CA (US); Mostafa KHOSHNEVISAN, San Diego, CA (US)

(21) Appl. No.: 19/199,146

(22) Filed: May 5, 2025

(51) Int. Cl. H04L 1/1812; H04L 1/00

(52) U.S. Cl. CPC H04L 1/1812; H04L 1/0003; H04L 1/0061

(57) ABSTRACT

Various aspects of the present disclosure generally relate to wireless communication. In some aspects, a user equipment (UE) may identify a retransmission step size for hybrid automatic repeat request (HARQ) retransmissions using a reserved modulation and coding scheme (MCS) with continuous rate matching, wherein the retransmission step size is in accordance with at least one of a code rate of the MCS, a low-density parity check (LDPC) base graph, or a maximum number of permitted HARQ retransmissions. The UE may select, based at least in part on the retransmission step size, a starting point for rate matching of one or more coded bits in a buffer associated with a HARQ retransmission. The UE may communicate the HARQ retransmission using the starting point for rate matching of the one or more coded bits. Numerous other aspects are described.

### FIELD OF THE DISCLOSURE

Aspects of the present disclosure generally relate to wireless communication and specifically relate to techniques, apparatuses, and methods associated with step size identification for hybrid automatic repeat request retransmissions.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

In some aspects, a method of wireless communication performed by a user equipment (UE) includes identifying a retransmission step size for hybrid automatic repeat request (HARQ) retransmissions using a reserved modulation and coding scheme (MCS) with continuous rate matching, wherein the retransmission step size is in accordance with at least one of a code rate of the MCS, a low-density parity check (LDPC) base graph, or a maximum number of permitted HARQ retransmissions; selecting, based at least in part on the retransmission step size, a starting point for rate matching of one or more coded bits in a buffer associated with a HARQ retransmission; and communicating the HARQ retransmission using the starting point for rate matching of the one or more coded bits.

In some aspects, a method of wireless communication performed by a network node includes transmitting configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; and communicating the HARQ retransmission to a UE using the retransmission step size.

In some aspects, an apparatus for wireless communication at a UE includes one or more memories; and one or more processors, the one or more processors, individually or collectively and based at least in part on information stored in the one or more memories, being configured to: identify a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; select, based at least in part on the retransmission step size, a starting point for rate matching of one or more coded bits in a buffer associated with a HARQ retransmission; and communicate the HARQ retransmission using the starting point for rate matching of the one or more coded bits.

In some aspects, an apparatus for wireless communication at a network node includes one or more memories; and one or more processors, the one or more processors, individually or collectively and based at least in part on information stored in the one or more memories, being configured to: transmit configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; and communicate the HARQ retransmission to a UE using the retransmission step size.

In some aspects, a non-transitory computer-readable medium storing a set of instructions for wireless communication that, when executed by one or more processors of a UE, cause the UE to: identify a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; select, based at least in part on the retransmission step size, a starting point for rate matching of one or more coded bits in a buffer associated with a HARQ retransmission; and communicate the HARQ retransmission using the starting point for rate matching of the one or more coded bits.

In some aspects, a non-transitory computer-readable medium storing a set of instructions for wireless communication that, when executed by one or more processors of a network node, cause the network node to: transmit configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; and communicate the HARQ retransmission to a UE using the retransmission step size.

In some aspects, an apparatus for wireless communication includes means for identifying a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; means for selecting, based at least in part on the retransmission step size, a starting point for rate matching of one or more coded bits in a buffer associated with a HARQ retransmission; and means for communicating the HARQ retransmission using the starting point for rate matching of the one or more coded bits.

In some aspects, an apparatus for wireless communication includes means for transmitting configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; and means for communicating the HARQ retransmission to a UE using the retransmission step size.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIGS. 2A-2C are diagrams illustrating examples of redundancy version identifiers and continuous rate matching.

FIGS. 3A-3F are diagrams illustrating examples of identifying retransmission step sizes for hybrid automatic repeat request retransmissions.

FIG. 4 is a diagram illustrating an example process performed, for example, at a user equipment (UE) or an apparatus of a UE.

FIG. 5 is a diagram illustrating an example process performed, for example, at a network node or an apparatus of a network node.

FIG. 6 is a diagram of an example apparatus for wireless communication.

FIG. 7 is a diagram of an example apparatus for wireless communication.

### DETAILED DESCRIPTION

Hybrid automatic repeat request (HARQ) is a protocol for improving a reliability of data transmissions. The HARQ process may include data transmission, acknowledgment (ACK) or negative acknowledgment (NACK) reception, and retransmissions using incremental redundancy controlled by HARQ redundancy version (RV) identifiers (ID) (collectively, RVID). Each data transmission instance, whether an initial transmission or a re-transmission, may be associated with an HARQ RVID that determines the selection of bits for transmission. These bits may be selected from a circular buffer using a specific interleaving pattern for each RV, which may provide distinct portions of the rate-matched output to enhance the likelihood of successful decoding at the receiver.

In some cases, the HARQ process may be designed to support up to four RVIDs, where each RVID corresponds to different starting bits within a set transmitted from a circular buffer. While current HARQ processes may be robust against missed grants due to fixed starting points for each RVID, these HARQ processes may lead to overlapping of coded bits among different RVIDs, thereby resulting in a potential loss of coding gain when repetitions occur. In some cases, problems may occur when attempting to enhance coding gain for continuous rate-matching, particularly when a reserved modulation and coding scheme (MCS) (which may also be referred to as implicit MCS) is used. For example, the system may design the retransmission step size to minimize overlap between different retransmissions. However, a fixed number of retransmissions with the same step size in the current RVID cycling may lead to redundancy, which is less desirable compared to continuous rate-matching that can cover the full circular buffer without repetition. Additionally, the step size for retransmissions may negatively impact the trade-off between delay and end-to-end link performance. For example, a smaller step size could result in multiple retransmissions, introducing more delay, while a larger step size may reduce the number of required retransmissions for a transport block (TB) to be successfully transmitted, but might offer less coding gain.

Various aspects generally relate to enhancing the coding gain HARQ processes in wireless communication systems, particularly when using continuous rate-matching and reserved MCS. In some aspects, a user equipment (UE) may identify a retransmission step size for HARQ retransmissions in accordance with a code rate of the MCS, a type of low-density parity-check (LDPC) base graph, or a maximum number of permitted HARQ retransmissions. The UE may select a starting point for rate matching of coded bits in the buffer associated with a HARQ retransmission in accordance with the identified retransmission step size and may communicate the HARQ retransmission using this selected starting point.

In some aspects, the retransmission step size may be determined based at least in part on a combination of two or more of the code rate of the MCS, the LDPC base graph, or the maximum number of permitted HARQ retransmissions. This information can be signaled using a dedicated field in a downlink or uplink grant or via a radio resource control (RRC) message. Additionally or alternatively, the step size may be identified according to a mapping from these parameters to the step size, configured via a mapping table indicated in an RRC message, allowing for flexible and adaptive step size determination based on current transmission conditions. In some aspects, the retransmission step size may be the same for all HARQ retransmissions associated with a communication. In some other aspects, the retransmission step size may be different for two or more HARQ retransmissions associated with the communications, for example, with different step sizes for initial and subsequent HARQ retransmissions. In some aspects, the step size can be indicated in a redundancy version identifier associated with the HARQ retransmission, which may be mapped to the step size along with other parameters such as the code rate of the MCS, the LDPC base graph, or the maximum number of permitted HARQ retransmissions. These techniques enhance the coding gain, reduce the number of retransmissions required for successful data decoding, and improve overall system throughput, contributing to a more reliable and robust wireless communication system.

Particular aspects of the subject matter described in this disclosure can be implemented to realize one or more potential technical advantages. By identifying the retransmission step size based on such factors, the described techniques can be used to minimize the overlap between different HARQ retransmissions, thereby maximizing the unique information bits sent during each retransmission and enhancing overall coding gain. This optimization may lead to a more efficient utilization of radio resources, which can potentially reduce the number of retransmissions required for successful data decoding, thereby conserving network resources and improving system throughput. This may result in the consumption of fewer processing resources, memory resources, and network resources, among other examples.

In some aspects, the step size for retransmissions can be signaled using dedicated fields in downlink or uplink grants, or via an RRC message, providing a technical mechanism for efficient communication of retransmission parameters. Furthermore, the determination of the retransmission step size using a mapping configured via RRC may allow for a system that can adapt to various transmission conditions by associating different parameters with appropriate step sizes, thereby enhancing the robustness and flexibility of the system. In some aspects, allowing the retransmission step size to vary among different HARQ retransmissions within the same communication may enable tailoring the retransmission strategy to adapt to changing channel conditions or UE capabilities. This variable step size approach can contribute to a more reliable wireless communication by optimizing the trade-off between minimizing delay and maximizing coding gain, which may assist with maintaining the integrity and efficiency of high-speed data communications. These example advantages, among others, are described in more detail below.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

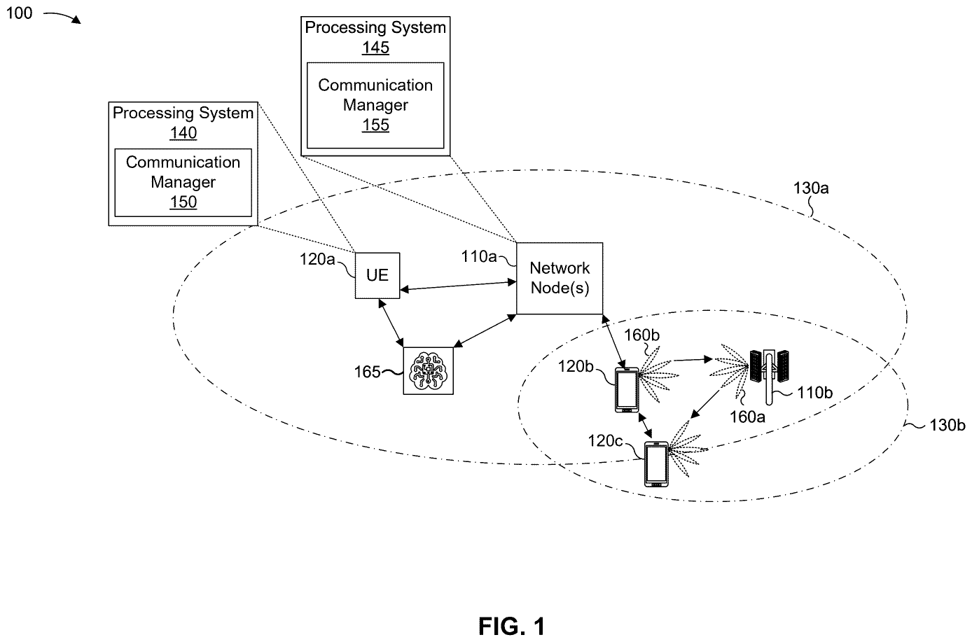

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR 4 (52.6 GHz through 114.25 GHz), and FR 5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the

UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may identify a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; select, based at least in part on the retransmission step size, a starting point for rate matching of one or more coded bits in a buffer associated with a HARQ retransmission; and communicate the HARQ retransmission using the starting point for rate matching of the one or more coded bits. Additionally, or alternatively, the communication manager 150 may perform one or more other operations described herein.

In some aspects, the network node 110 may include a communication manager 155. As described in more detail elsewhere herein, the communication manager 155 may transmit configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; and communicate the HARQ retransmission to a UE using the retransmission step size. Additionally, or alternatively, the communication manager 155 may perform one or more other operations described herein.

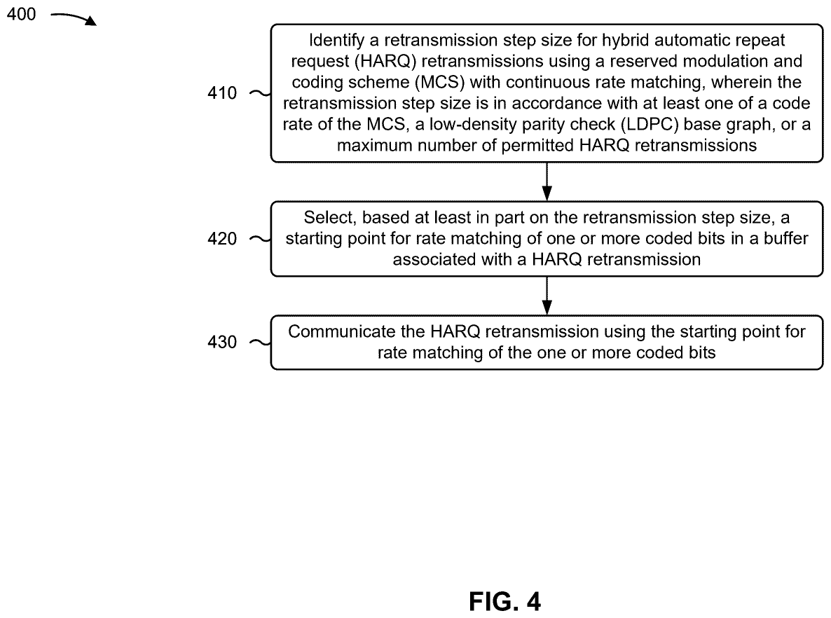

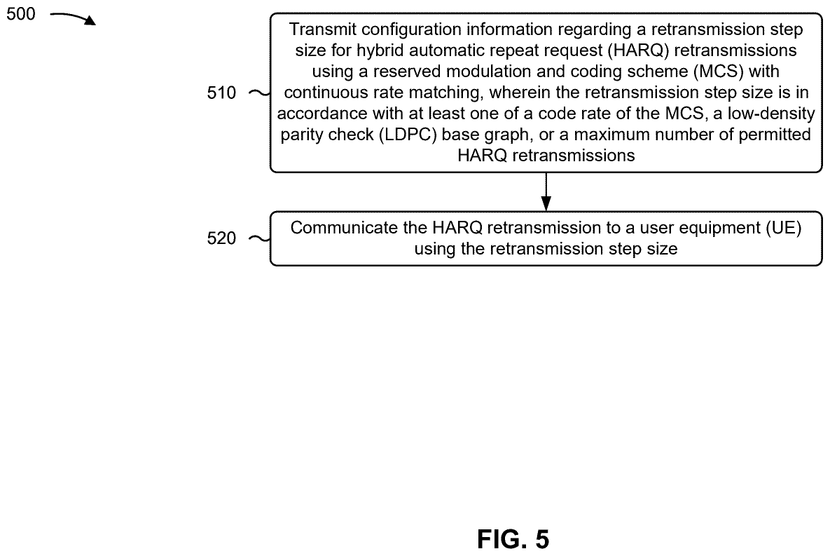

The network node 110, the processing system 145 of the network node 110, the UE 120, the processing system 140 of the UE 120, or any other component(s) of FIG. 1 may implement one or more techniques or perform one or more operations associated with step size identification for HARQ retransmissions, as described in more detail elsewhere herein. For example, the processing system 145 of the network node 110, or the processing system 140 of the UE 120 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, or other processes as described herein. In some examples, executing instructions may include running the instructions, converting the instructions, compiling the instructions, or interpreting the instructions, among other examples.

In some aspects, the UE 120 includes means for identifying a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; means for selecting, based at least in part on the retransmission step size, a starting point for rate matching of one or more coded bits in a buffer associated with a HARQ retransmission; or means for communicating the HARQ retransmission using the starting point for rate matching of the one or more coded bits. The means for the UE 120 to perform operations described herein may include, for example, one or more of communication manager 150, processing system 140, a radio, one or more RF chains, one or more transceivers, one or more antennas, one or more modems, a reception component, or a transmission component, among other examples.

In some aspects, the network node 110 includes means for transmitting configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions; or means for communicating the HARQ retransmission to a UE using the retransmission step size. The means for the network node 110 to perform operations described herein may include, for example, one or more of communication manager 155, processing system 145, a radio, one or more RF chains, one or more transceivers, one or more antennas, one or more modems, a reception component, or a transmission component, among other examples.

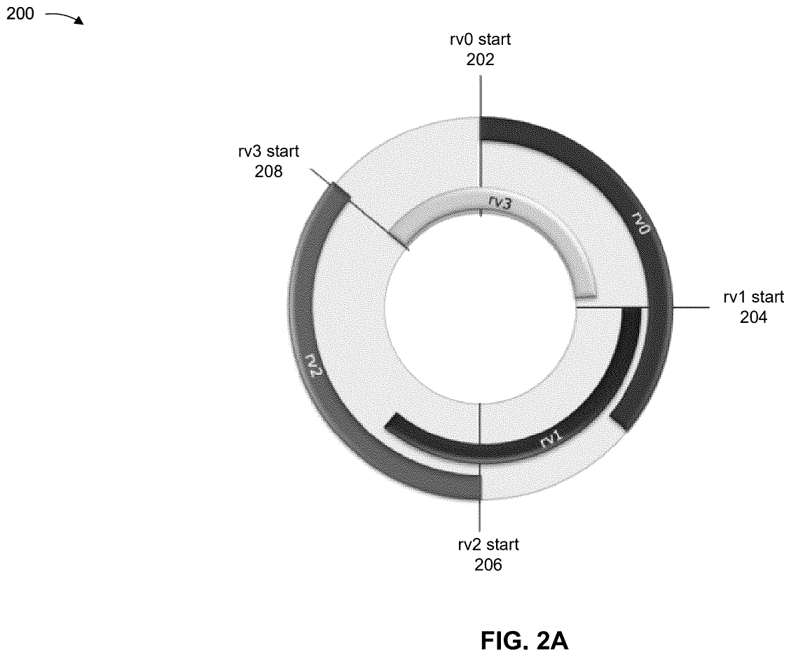

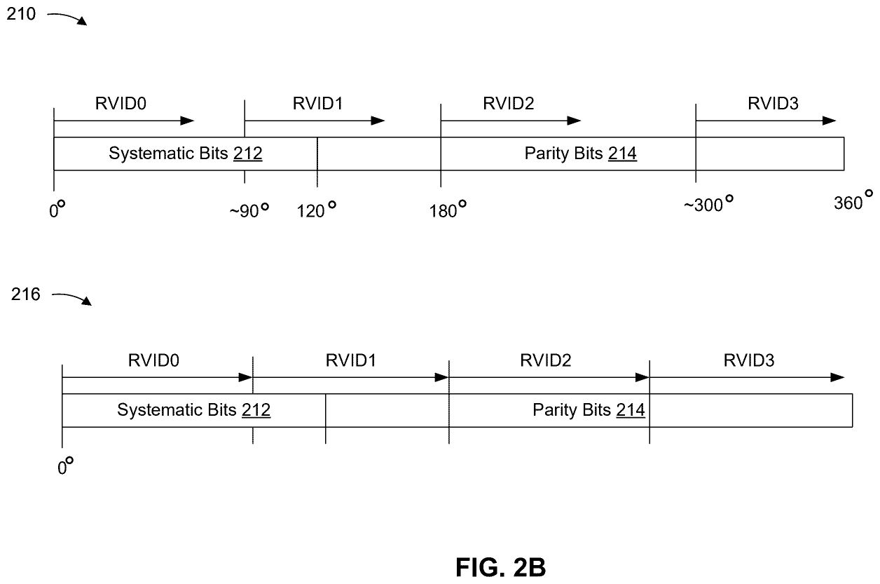

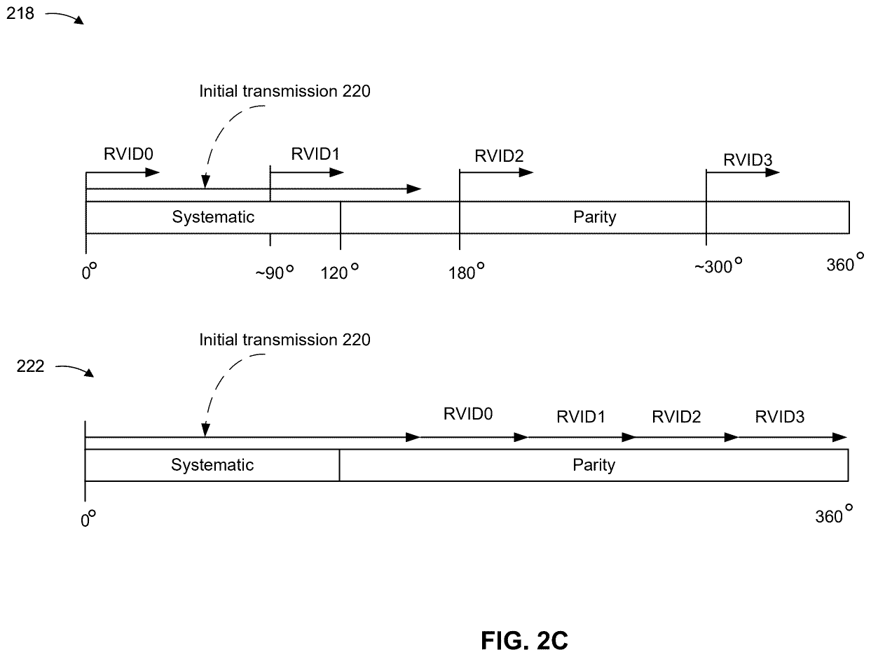

FIGS. 2A-2C are diagrams illustrating examples of redundancy version identifiers and continuous rate matching.

Data transmission and reception in 5G NR systems (and other wireless communications systems) may include the processes of data transmission, receiving acknowledgments or negative acknowledgments, and retransmission (e.g., in the event that a NACK is received). The HARQ mechanism in these wireless communication systems may perform retransmissions in accordance with an incremental redundancy, which may be controlled by HARQ RVIDs. At each instance of data transmission, whether it is an initial transmission or a retransmission, an HARQ RVID may be indicated to determine which set of bits are selected for transmission. Different RVIDs correspond to different starting bits of a set of bits being transmitted. The selection of bits in different redundancy versions may be achieved using a circular buffer and a specific interleaving pattern for each RV. Consequently, each RV may provide a different portion of the rate-matched output, increasing the chances of successful decoding at the receiver. Each RV may be constructed from the bits in a circular buffer that are stored during the rate match process.

In some wireless communication systems, up to four RVs and four associated RVIDs may be supported. As shown in FIG. 2A and example 200, a circular buffer may include a first RV (shown as rv0 starting at rv0 start 202), a second RV (shown as rv1 starting at rv1 start 204), a third RV (shown as rv2 starting at rv2 start 206), and a fourth RV (shown as rv3 starting at rv3 start 208). However, in some cases, rate-matched coded bits may overlap with one or more of the RVIDs. For example, rv0, rv1, and rv3 may be at least partially overlapping. This may result in a lower coding gain compared to continuous rate matching, where there may be no overlap. To further enhance the coding gain associated with the incremental redundancy for HARQ, the number of RVIDs may be increased to more than four. However, this may result in an increase in the bit-width of the RVID field of the scheduling DCI, resulting in increased overhead. Instead of increasing the number of RVIDs, the wireless communication system may switch to continuous rate matching.

Continuous rate matching can improve the coding gain of HARQ systems by avoiding repetition as much as possible to achieve the most coding gain. As shown in FIG. 2B and example 210, a circular buffer may be used for transmitting systematic bits 212 and parity bits 214. In example 210, four RVIDs (shown as RVID0, RVID1, RVID2, and RVID3) may be mapped to fixed coded bit starting positions in the circular buffer, almost uniformly distributed in the circle, except for RVID 3, which occurs after the 270° point in the circular buffer. This may results in some unwanted overlapping of coded bits across different RVIDs, leading to a loss of coding gain when repetition is used. However, as shown in example 216, continuous rate matching can be used to avoid repetition (as much as possible) to achieve the highest coding gain.

In some cases, a transport block size (TBS) may be determined using a resource allocation indicated in DCI (e.g., frequency domain resource allocation (FDRA), time domain resource allocation (TDRA), or a number of layers, among other examples), excluding the demodulation reference signal (DMRS) resource elements (RE) as well as the modulation order and code rate indicated in the DCI (e.g., in the MCS field of the DCI). Reserved MCS (implicit MCS) can be used for retransmissions of the same TB. However, reserved MCS may only indicate the modulation order for retransmission, but may not indicate the coding rate. When reserved MCS is indicated, the UE 120 may need to be configured with the TBS from earlier transmissions of the same TB, otherwise, the UE 120 may not be able to decode the TB.

In some cases, with reserved MCS, a network node 110 may be configured with information indicating that the DCI scheduling the initial transmission is not missed, thereby allowing the network node 110 to utilize continuous rate matching to improve the coding gain at least for the initial transmission and the first retransmission. This implies that, conditioned on the network using the reserved MCS, it may be more straightforward to utilize continuous rate matching. When a reserved MCS (implicit MCS) is signaled for an incremental redundancy HARQ (IR-HARQ) retransmission after an explicit MCS is received and the TBS is configured, one or more processes can be used to provide redundancy for the successful decoding of the TB. In a first example, if a delta CQI from the UE 120 is received, the network node 110 can determine exactly how much redundancy is needed to retransmit (e.g., just enough for the UE 120 to decode). However, even with the delta CQI received from the UE 120, the estimated amount of needed redundancy might not be accurate due to estimation errors, and more retransmissions might be needed for successful decoding of the TB, resulting in more delay. In a second example, without a delta CQI from the UE 120, the network node 110 can retransmit in smaller steps and can terminate when the UE 120 is able to decode. However, this may introduce additional delay into the system. With reserved MCS, the retransmission step size (which may be denoted by S) becomes crucial, striking a trade-off between delay and end-to-end link performance.

In some cases, to enhance the coding gain of continuous rate matching when reserved MCS (implicit MCS) is selected, the retransmission step size S can be designed to minimize the overlap between different retransmissions. This may be used to harvest as much coding gain as possible by sending new bits (either information or parity bits) compared to sending bits that have already been transmitted before. As shown in FIG. 2C and example 218, five transmissions (including an initial transmission 220 plus four retransmissions associated with RVID0, RVID1, RVID2, and RVID3, respectively) can cover the full circular buffer with continuous rate matching and implicit MCS, with a step size of retransmissions that is less than the initial transmission allocation size. However, with the same number of retransmissions and the same step size, traditional RVID cycling may result in bits that have already been transmitted before being transmitted again, resulting in less coding gain compared to continuous rate matching. In contrast, as shown in example 222, the initial transmission 220 and the four retransmissions (associated with RVID0, RVID1, RVID2, and RVID3, respectively) may not overlap, which may reduce or eliminate bits that have already been transmitted being transmitted again.

As described herein, a retransmission step size may enable a trade-off between delay and end-to-end link performance. For example, a smaller step size may result in many retransmissions (e.g., more delay), while a larger step size may result in a smaller number of required retransmissions for a TB to go through (but with less coding gain). In some cases, if the delta CQI is configured at the network node 110 (e.g., received by the network node 110 from the UE 120), the amount of redundancy required for retransmissions can be determined using the delta CQI. In contrast, if the delta CQI is not known, a fixed small step size can be used for retransmissions. However, the network node 110 (and other devices) may not be configured to properly determine this step such that a good trade-off between latency and coding gain is achieved.

As indicated above, FIGS. 2A-2C are provided as examples. Other examples may differ from what is described with regard to FIGS. 2A-2C.

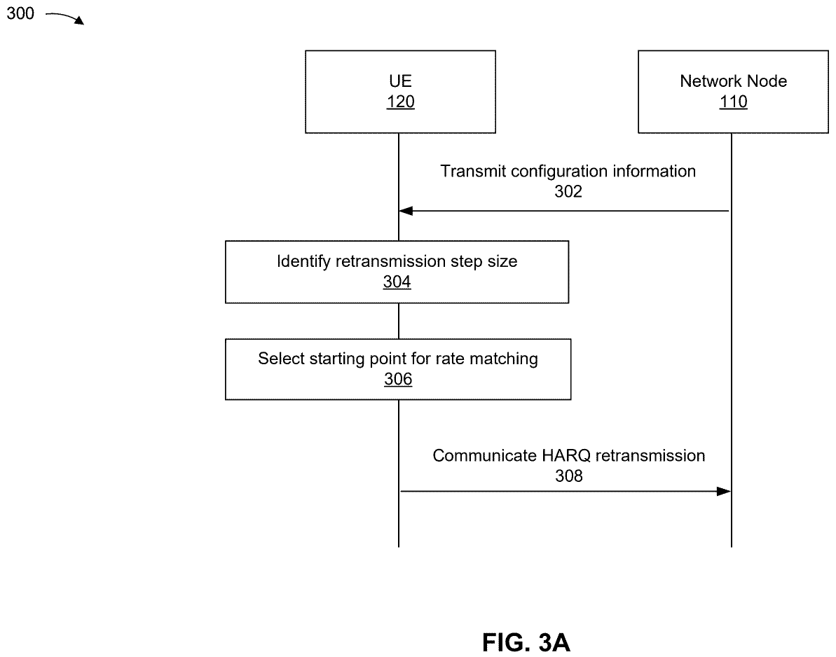

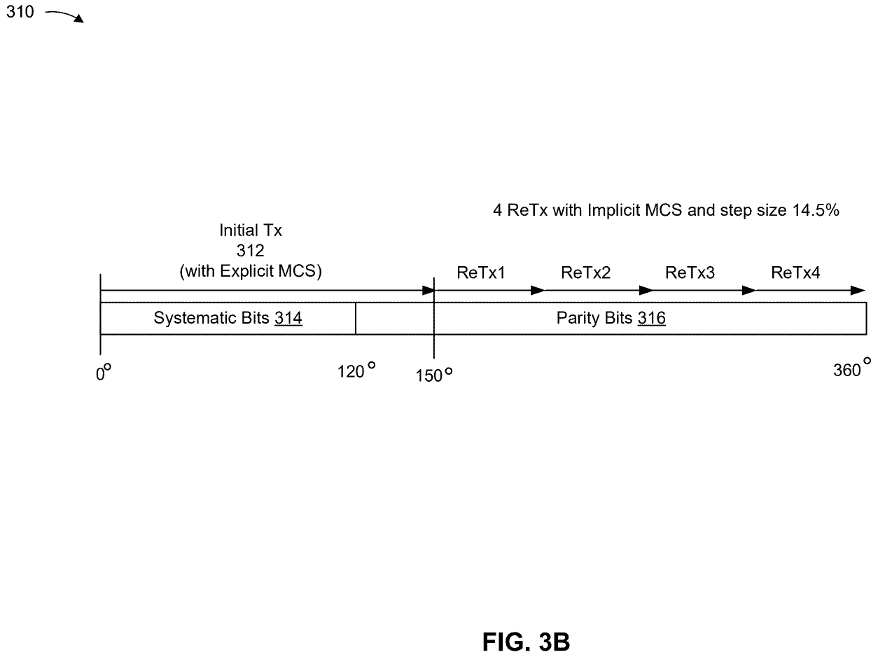

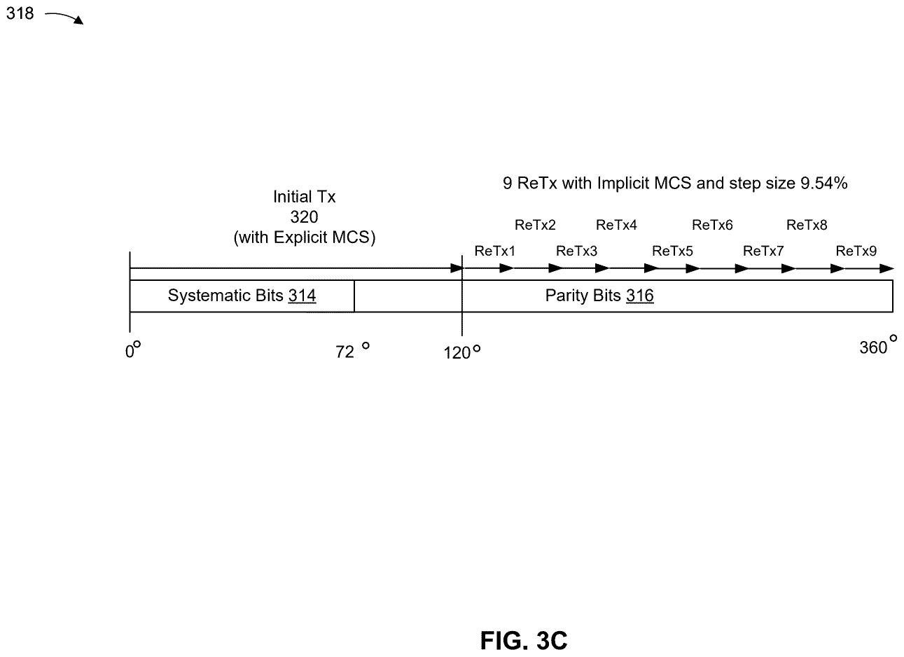

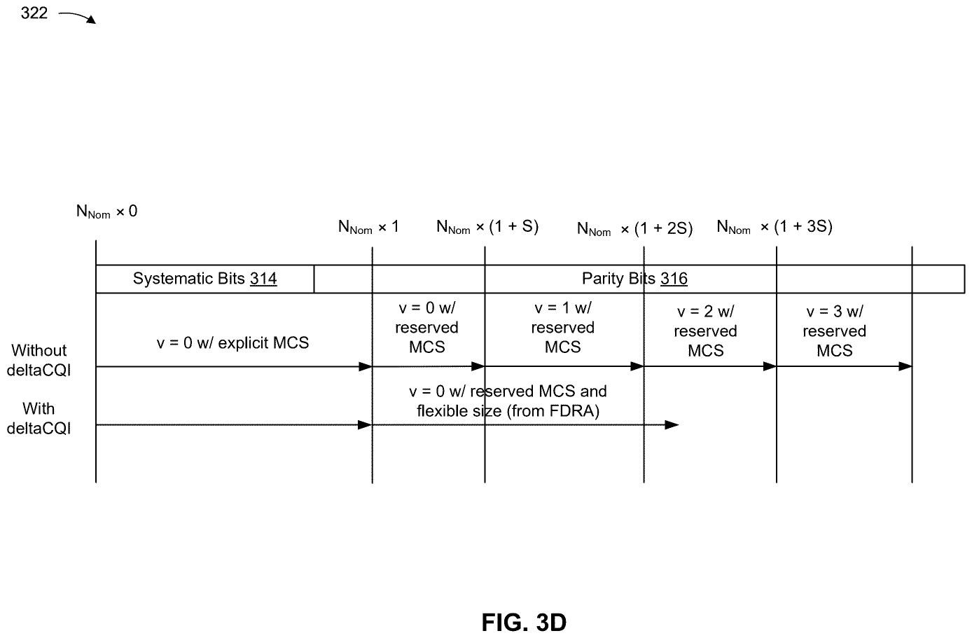

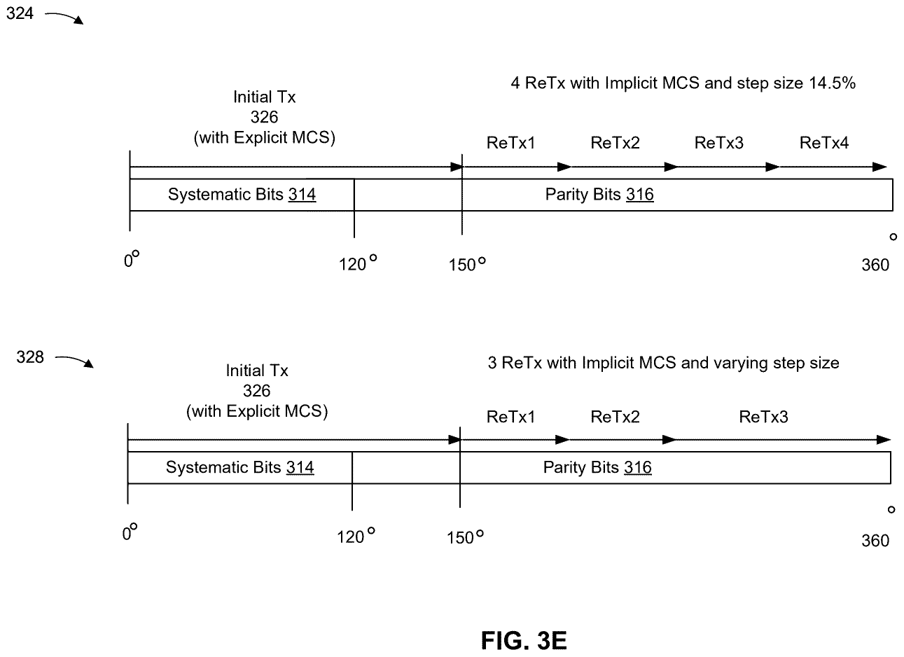

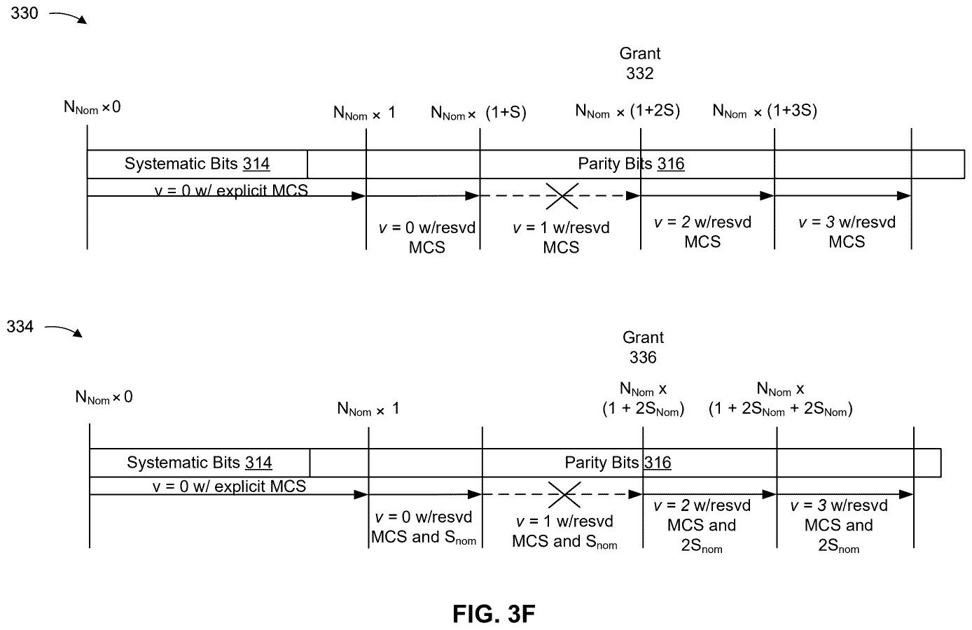

FIGS. 3A-3F are diagrams illustrating examples of identifying retransmission step sizes for hybrid automatic repeat request retransmissions. As shown in FIG. 3A and example 300, the network node 110 may communicate with the UE 120 (and vice versa).

As shown by reference number 302, the network node 110 may transmit configuration information to the UE 120. For example, the network node 110 can signal the maximum number of retransmissions via a dedicated field in the downlink or uplink grant, or through an RRC message. This may enable the UE 120 to receive necessary parameters for determining retransmission step size.

In some aspects, the maximum number of permitted HARQ retransmissions is signaled using a dedicated field included in a downlink grant for physical downlink shared channel communications or in an uplink grant for physical uplink shared channel communications. For example, the network node 110 may include a specific field in the grant message that directly indicates the maximum number of retransmissions allowed. Using a dedicated field ensures clear and direct communication of the retransmission limit. Additionally, or alternatively, the maximum number of permitted HARQ retransmissions is signaled using a radio resource control message. For example, the network node 110 may use an RRC message to convey the maximum retransmission limit to the UE 120. Using an RRC message allows for flexible and comprehensive signaling of the retransmission parameters.

In some aspects, as shown by reference number 304, the UE 120 may identify a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions. This approach balances latency and coding gain effectively. In some aspects, the retransmission step size is in accordance with a combination of two or more of the code rate of the MCS, the LDPC base graph, or the maximum number of permitted HARQ retransmissions. For example, the UE 120 may calculate the step size by considering both the MCS code rate and the LDPC base graph type. Combining multiple parameters may ensure a more accurate and efficient step size determination. Additionally, or alternatively, the retransmission step size may be identified in accordance with a mapping from at least one of the code rate of the MCS, the LDPC base graph, or the maximum number of permitted HARQ retransmissions to the step size. For example, the UE 120 may use a predefined mapping table to determine the appropriate step size based on the given parameters. Using a mapping approach may provide a structured and consistent method for step size identification. Additionally, or alternatively, the mapping from at least one of the code rate of the MCS, the LDPC base graph, or the maximum number of permitted HARQ retransmissions to the step size may be configured via a mapping table indicated in a radio resource control message. For example, the RRC message may include a table that the UE 120 uses to look up the step size. Configuring the mapping table via RRC message may enable dynamic updates and flexibility in step size determination.

In some aspects, the retransmission step size may be identified for one or more HARQ retransmissions associated with a downlink communication from a network node to the UE 120. For example, the UE 120 may determine the step size for retransmissions of data received from the network node 110. Identifying the step size for downlink communications may ensure that the retransmissions are efficient and effective. Additionally, or alternatively, the retransmission step size may be identified for one or more HARQ retransmissions associated with an uplink communication from the UE 120 to a network node. For example, the UE 120 may calculate the step size for data it needs to retransmit to the network node 110. Identifying the step size for uplink communications may help maintain link reliability and performance.

In some aspects, the retransmission step size is a same step size for all HARQ retransmissions associated with a communication. For example, the UE 120 may use a uniform step size for all retransmissions of a particular data block. This may be useful for the case of missing DCI events. For example, if two or more grants (note that initial DCI with explicit MCS is not assumed to be missed), the amount to be skipped in the circular buffer can be determined based at least in part on the RVID of the current received and previously received grants, the base graph, or the code rate of explicit MCS, among other examples.

In some aspects, identifying the retransmission step size comprises identifying at least a first retransmission step size for a HARQ retransmission associated with a communication and a second retransmission step size for another HARQ retransmission associated with the communication. For example, the UE 120 might use a smaller step size for initial retransmissions and a larger step size for subsequent ones. Differentiating step sizes can optimize delay and efficiency across multiple retransmissions. Additionally, or alternatively, the HARQ retransmission may be one or more initial HARQ retransmissions and the other HARQ retransmission may be one or more subsequent HARQ retransmissions, where the first retransmission step size is shorter than the second retransmission step size. For example, the UE 120 may prioritize quicker initial retransmissions with a smaller step size and allocate more time for later retransmissions with a larger step size. This approach may help to minimize initial delay while still ensuring overall transmission reliability.

In some aspects, the first retransmission step size is indicated in a redundancy version identifier associated with the HARQ retransmission and the second retransmission step size is indicated in another redundancy version identifier associated with the other HARQ retransmission. For example, the step sizes may be encoded directly in the redundancy version identifiers (RVIDs) within the retransmission messages. Using RVIDs to indicate step sizes provides a straightforward and integrated method for step size signaling. Additionally, or alternatively, the retransmission step size may be in accordance with a redundancy version identifier and at least one of the code rate of the MCS, the LDPC base graph, or the maximum number of permitted HARQ retransmissions. For example, the UE 120 may base the step size on a combination of the RVID and other transmission parameters. Combining RVIDs with other parameters allows for more precise control over the retransmission process. Additionally, or alternatively, a mapping indicated in a radio resource control message maps at least one of a redundancy version identifier, the code rate of the MCS, the LDPC base graph, or the maximum number of permitted HARQ retransmissions to the retransmission step size. For example, the RRC message may define a detailed mapping schema that the UE 120 uses to determine the correct step size. Mapping via RRC message may improve flexibility and adaptability in step size configuration.

As shown by reference number 306, the UE 120 may select, based at least in part on the retransmission step size, a starting point for rate matching of one or more coded bits in a buffer associated with a HARQ retransmission. For example, if the UE 120 initially covers 33% of the buffer with the first transmission, the UE 120 may divide the remaining 67% into segments based on the maximum number of retransmissions allowed, such as 9 segments of 7.44% each. This may ensure efficient utilization of the buffer space and minimizes overlap of retransmitted bits.

As shown by reference number 308, the UE 120 may communicate the HARQ retransmission to the network node 110 using the starting point for rate matching of the one or more coded bits. For example, after determining the step size, the UE 120 can start rate matching at the calculated point in the buffer, ensuring new bits are sent with each retransmission rather than repeating previously transmitted bits. This may improve overall link performance by enhancing coding gain.

In some aspects, if the delta-CQI is not known, a fixed small step size can be used for retransmissions. For example, in the absence of delta-CQI information, the UE 120 might utilize a predefined small step size, such as 5% of the buffer, for each retransmission. This approach may improve a likelihood that retransmissions can still proceed efficiently even without delta-CQI data.

As shown in FIG. 3B and example 310, the UE 120 may use a circular buffer with Base Graph 1 and a code rate of 0.8. The LDPC base graph may be determined using a TB size and the code rate. In this example, an initial transmission with explicit MCS (shown as Initial Tx 312) may use 42% of the circular buffer, including all systematic bits 314 and a few parity bits 316. Subsequently, one or more retransmissions (ReTx) may be scheduled with reserved MCS, and a step size may be selected such that the allocation size of retransmission is smaller (e.g., significantly smaller) than that of the initial transmission with the explicit MCS. When continuous rate-matching is used, the retransmissions may continue to be used to send parity bits until a full cycle in the buffer is achieved. To determine the step size for retransmission, the UE 120 may determine how much of the circular buffer is left after the initial transmission (in this example, 58%). The remaining part of the buffer can be divided into equal segments depending on the maximum number of retransmissions. In this example, four retransmissions may be used (shown as ReTx1, ReTx2, ReTx3, and ReTx4, respectively), which results in a step size of 14.5%. Each retransmissions may then take place with a step size equal to the segment size.

As shown in FIG. 3C and example 318, the UE 120 may use a circular buffer with Base Graph 2, a code rate of 0.6, and a maximum number of retransmissions equal to nine (9). An initial Tx 320 (with explicit MCS) may occupy 33% of the buffer. To cover the rest of the buffer with reserved MCS and continuous rate-matching, and given that the maximum number of retransmissions is 9, a step size of 67% divided by 9, which equals 7.44%, can be selected for each retransmission, shown as ReTx1, ReTx2, ReTx3, ReTx4, ReTx5, ReTx6, ReTx7, ReTx8, and ReTx9, respectively. If another code rate is selected or the base graph is switched to Base Graph 1, the initial transmission may cover a different percentage of the buffer, and hence a different step size may be selected.

As shown in FIG. 3D and example 322, the retransmission step size may be used to determine the starting point for coded bits for each RVID (which may be used as a counter) with the reserved MCS. The rate matching starting point of a reserved MCS DCI may be determined by Nₙₒₘ (from the received explicit MCS DCI) and the RVID (represented by v) in the reserved MCS DCI. The rate matching starting point may be defined as (Nₙₒₘ×1+Nₙₒₘ×S×v)mod N_{CirBuf}, where N_{CirBuf} is the length of the circular buffer. This design may be optimized by the explicit MCS DCI using RVID0. Here, S is the step size for the reserved MCS RVID incremental (for example, S=25%). For an initial transmission without deltaCQI, v=0 (without explicit MCS) at Nₙₒₘ×0. For retransmissions without delta CQI, v=0 with reserved MCS at Nₙₒₘ×1, v=1 with reserved MCS for Nₙₒₘ×(1+S), v=2 with reserved MCS at Nₙₒₘ×(1+2S), and v=3 with reserved MCS at Nₙₒₘ×(1+3S). In contrast, for retransmissions with deltaCQI, v=0 with reserved MCS and a flexible data size (e.g., using FDRA).

As shown in FIG. 3E and example 324, the UE 120 may use a circular buffer with Base Graph 1 and a code rate of 0.8. The LDPC base graph may be determined using a TB size and the code rate. In this example, an initial transmission with explicit MCS (shown as Initial Tx 326) may use 42% of the circular buffer, including all systematic bits 314 and a few parity bits 316. The remaining part of the buffer can be divided into equal segments depending on the maximum number of retransmissions. In some examples, each retransmission may have the same step size. In these examples, four retransmissions may be used (shown as ReTx1, ReTx2, ReTx3, and ReTx4, respectively), each having a step size of 14.5%. In some other examples, different retransmissions may have different step sizes. For example, an initial retransmission (or a number of initial retransmissions) can have a smaller step size and a remainder of the retransmissions can have larger step sizes. As shown in example 328, the Initial Tx 326 may use 42% of the circular buffer, with three 58% of the buffer being allocated to three retransmissions. A first retransmission (ReTx1) and a second retransmission (ReTx2) may each use 14% of the buffer while a third retransmission (ReTx3) may use 28% of the buffer. This may reduce latency for the retransmissions and may reduce a number of DCI transmissions required for granting the retransmissions.

As shown in FIG. 3F and example 330, an initial transmission v=0 (without explicit MCS) may be performed at Nₙₒₘ×0. Additionally, a first retransmission, v=0 with reserved MCS, may be performed at Nₙₒₘ×1. However, a second retransmission v=1 with reserved MCS may not be performed at Nₙₒₘ×(1+S) (for example, the retransmission may fail). In this example, a third retransmission v=2 with reserved MCS at Nₙₒₘ×(1+2S) may be missed due to the missing grant with RVID v=1. The UE 120 may receive a grant 334 having v=2 with reserved MCS at Nₙₒₘ×(1+2S). Therefore, the UE 120 may perform the third retransmission v=3 with reserved MCS at Nₙₒₘ ×(1+3S). As show in example 334, an initial transmission v=0 (without explicit MCS) may be performed at Nₙₒₘ×0. Additionally, a first retransmission, v=0 with reserved MCS and S_{Nom} may be performed at Nₙₒₘ ×1. However, a second retransmission v=1 with reserved MCS may not be performed at Nₙₒₘ×(1+S) (for example, the retransmission may fail). In this example, a third retransmission v=2 with reserved MCS at Nₙₒₘ×(1+2S_{Nom}) may be missed due to the missing grant with RVID v=1. The UE 120 may receive a grant 338 having v=2 with reserved MCS, may skip in the buffer by Nₙₒₘ×Sₙₒₘ, and may start rate matching at Nₙₒₘ×(1+2S_{Nom}). Therefore, the UE 120 may perform the third retransmission v=3 with reserved MCS at Nₙₒₘ×(1+2S_{Nom}+2S_{Nom}).

As indicated above, FIGS. 3A-3F are provided as examples. Other examples may differ from what is described with regard to FIGS. 3A-3F.

FIG. 4 is a diagram illustrating an example process 400 performed, for example, at a UE or an apparatus of a UE. Example process 400 is an example where the apparatus or the UE (e.g., UE 120) performs operations associated with step size identification for HARQ retransmissions.

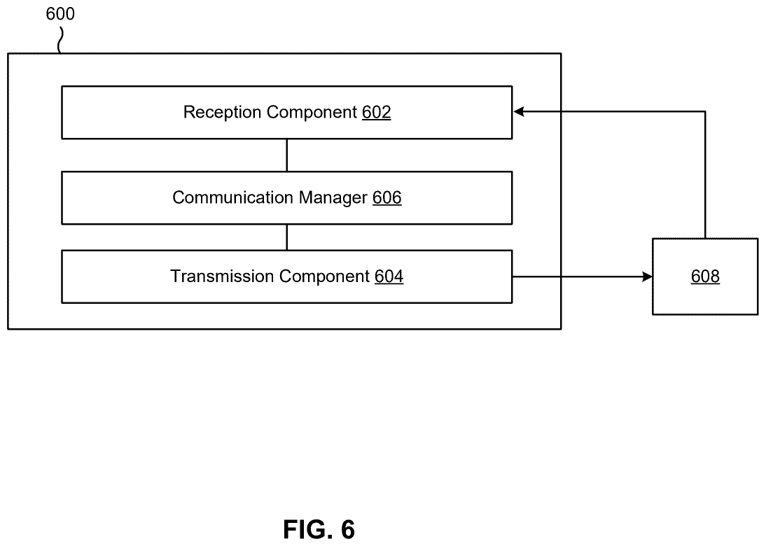

As shown in FIG. 4, in some aspects, process 400 may include identifying a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions (block 410). For example, the UE (e.g., using communication manager 606, depicted in FIG. 6) may identify a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions, as described above.

As further shown in FIG. 4, in some aspects, process 400 may include selecting, based at least in part on the retransmission step size, a starting point for rate matching of one or more coded bits in a buffer associated with a HARQ retransmission (block 420). For example, the UE (e.g., using communication manager 606, depicted in FIG. 6) may select, based at least in part on the retransmission step size, a starting point for rate matching of one or more coded bits in a buffer associated with a HARQ retransmission, as described above.

As further shown in FIG. 4, in some aspects, process 400 may include communicating the HARQ retransmission using the starting point for rate matching of the one or more coded bits (block 430). For example, the UE (e.g., using reception component 602, transmission component 604, or communication manager 606, depicted in FIG. 6) may communicate the HARQ retransmission using the starting point for rate matching of the one or more coded bits, as described above.

Process 400 may include additional aspects, such as any single aspect or any combination of aspects described below or in connection with one or more other processes described elsewhere herein.

In a first aspect, the retransmission step size is in accordance with a combination of two or more of the code rate of the MCS, the LDPC base graph, or the maximum number of permitted HARQ retransmissions.

In a second aspect, alone or in combination with the first aspect, the maximum number of permitted HARQ retransmissions is signaled using a dedicated field included in a downlink grant for physical downlink shared channel communications or in an uplink grant for physical uplink shared channel communications.

In a third aspect, alone or in combination with one or more of the first and second aspects, the maximum number of permitted HARQ retransmissions is signaled using a radio resource control message.

In a fourth aspect, alone or in combination with one or more of the first through third aspects, the retransmission step size is identified in accordance with a mapping from at least one of the code rate of the MCS, the LDPC base graph, or the maximum number of permitted HARQ retransmissions to the step size.

In a fifth aspect, alone or in combination with one or more of the first through fourth aspects, the mapping from at least one of the code rate of the MCS, the LDPC base graph, or the maximum number of permitted HARQ retransmissions to the step size is configured via a mapping table indicated in a radio resource control message.

In a sixth aspect, alone or in combination with one or more of the first through fifth aspects, the retransmission step size is identified for one or more HARQ retransmissions associated with a downlink communication from a network node to the UE.

In a seventh aspect, alone or in combination with one or more of the first through sixth aspects, the retransmission step size is identified for one or more HARQ retransmissions associated with an uplink communication from the UE to a network node.

In an eighth aspect, alone or in combination with one or more of the first through seventh aspects, the retransmission step size is a same step size for all HARQ retransmissions associated with a communication.

In a ninth aspect, alone or in combination with one or more of the first through eighth aspects, identifying the retransmission step size comprises identifying at least a first retransmission step size for a HARQ retransmission associated with a communication and a second retransmission step size for another HARQ retransmission associated with the communication.

In a tenth aspect, alone or in combination with one or more of the first through ninth aspects, the HARQ retransmission is one or more initial HARQ retransmissions and the other HARQ retransmission is one or more subsequent HARQ retransmissions, wherein the first retransmission step size is shorter than the second retransmission step size.

In an eleventh aspect, alone or in combination with one or more of the first through tenth aspects, the first retransmission step size is indicated in a redundancy version identifier associated with the HARQ retransmission and the second retransmission step size is indicated in another redundancy version identifier associated with the other HARQ retransmission.

In a twelfth aspect, alone or in combination with one or more of the first through eleventh aspects, the retransmission step size is in accordance with a redundancy version identifier and at least one of the code rate of the MCS, the LDPC base graph, or the maximum number of permitted HARQ retransmissions.

In a thirteenth aspect, alone or in combination with one or more of the first through twelfth aspects, a mapping indicated in a radio resource control message maps at least one of a redundancy version identifier, the code rate of the MCS, the LDPC base graph, or the maximum number of permitted HARQ retransmissions to the retransmission step size.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node. Example process 500 is an example where the apparatus or the network node (e.g., network node 110) performs operations associated with step size identification for HARQ retransmissions.

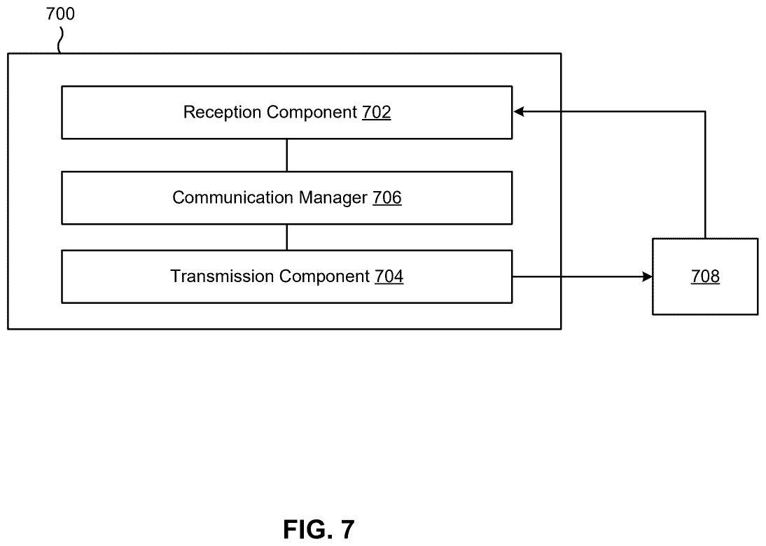

As shown in FIG. 5, in some aspects, process 500 may include transmitting configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions (block 510). For example, the network node (e.g., using transmission component 704 or communication manager 706, depicted in FIG. 7) may transmit configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions, as described above.

As further shown in FIG. 5, in some aspects, process 500 may include communicating the HARQ retransmission to a UE using the retransmission step size (block 520). For example, the network node (e.g., using reception component 702, transmission component 704, or communication manager 706, depicted in FIG. 7) may communicate the HARQ retransmission to a UE using the retransmission step size, as described above.

Process 500 may include additional aspects, such as any single aspect or any combination of aspects described below or in connection with one or more other processes described elsewhere herein.

In a first aspect, the retransmission step size is in accordance with a combination of two or more of the code rate of the MCS, the LDPC base graph, or the maximum number of permitted HARQ retransmissions.

In a second aspect, alone or in combination with the first aspect, the maximum number of permitted HARQ retransmissions is signaled to the UE using a dedicated field included in a downlink grant for physical downlink shared channel communications or in an uplink grant for physical uplink shared channel communications.

In a third aspect, alone or in combination with one or more of the first and second aspects, the maximum number of permitted HARQ retransmissions is signaled using a radio resource control message.

In a fourth aspect, alone or in combination with one or more of the first through third aspects, the retransmission step size is identified in accordance with a mapping from at least one of the code rate of the MCS, the LDPC base graph, or the maximum number of permitted HARQ retransmissions to the step size.

In a fifth aspect, alone or in combination with one or more of the first through fourth aspects, the mapping from at least one of the code rate of the MCS, the LDPC base graph, or the maximum number of permitted HARQ retransmissions to the step size is configured via a mapping table indicated in a radio resource control message.

In a sixth aspect, alone or in combination with one or more of the first through fifth aspects, the retransmission step size is identified for one or more HARQ retransmissions associated with a downlink communication from the network node to the UE.

In a seventh aspect, alone or in combination with one or more of the first through sixth aspects, the retransmission step size is identified for one or more HARQ retransmissions associated with an uplink communication from the UE to the network node.

In an eighth aspect, alone or in combination with one or more of the first through seventh aspects, the retransmission step size is a same step size for all HARQ retransmissions associated with a communication.

In a ninth aspect, alone or in combination with one or more of the first through eighth aspects, step size comprises at least a first retransmission step size for a HARQ retransmission associated with a communication and a second retransmission step size for another HARQ retransmission associated with the communication.

In a tenth aspect, alone or in combination with one or more of the first through ninth aspects, the HARQ retransmission is one or more initial HARQ retransmissions and the other HARQ retransmission is one or more subsequent HARQ retransmissions, wherein the first retransmission step size is shorter than the second retransmission step size.

In an eleventh aspect, alone or in combination with one or more of the first through tenth aspects, the first retransmission step size is indicated in a redundancy version identifier associated with the HARQ retransmission and the second retransmission step size is indicated in another redundancy version identifier associated with the other HARQ retransmission.

In a twelfth aspect, alone or in combination with one or more of the first through eleventh aspects, the retransmission step size is in accordance with a redundancy version identifier and at least one of the code rate of the MCS, the LDPC base graph, or the maximum number of permitted HARQ retransmissions.

In a thirteenth aspect, alone or in combination with one or more of the first through twelfth aspects, a mapping indicated in a radio resource control message maps at least one of a redundancy version identifier, the code rate of the MCS, the LDPC base graph, or the maximum number of permitted HARQ retransmissions to the retransmission step size.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIGS. 3A-3F. Additionally, or alternatively, the apparatus 600 may be configured to perform one or more processes described herein, such as process 400 of FIG. 4. In some aspects, the apparatus 600 or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The communication manager 606 may identify a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions. The communication manager 606 may select, based at least in part on the retransmission step size, a starting point for rate matching of one or more coded bits in a buffer associated with a HARQ retransmission. The reception component 602 or the transmission component 604 may communicate the HARQ retransmission using the starting point for rate matching of the one or more coded bits.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a network node, or a network node may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIGS. 3A-3F. Additionally, or alternatively, the apparatus 700 may be configured to perform one or more processes described herein, such as process 500 of FIG. 5. In some aspects, the apparatus 700 or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 or the transmission component 704 may include or may be included in a network interface. The network interface may be configured to obtain or output signals for the apparatus 700 via one or more communications links, such as a backhaul link, a midhaul link, or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The transmission component 704 may transmit configuration information regarding a retransmission step size for HARQ retransmissions using a reserved MCS with continuous rate matching, wherein the retransmission step size is in accordance with at least one of a code rate of the MCS, an LDPC base graph, or a maximum number of permitted HARQ retransmissions. The reception component 702 or the transmission component 704 may communicate the HARQ retransmission to a UE using the retransmission step size.

The number and arrangement of components shown in FIG. 7 are provided as an example. In practice, there may be additional components, fewer components, different components, or differently arranged components than those shown in FIG. 7.

Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a user equipment (UE), comprising: identifying a retransmission step size for hybrid automatic repeat request (HARQ) retransmissions using a reserved modulation and coding scheme (MCS) with continuous rate matching, wherein the retransmission step size is in accordance with at least one of a code rate of the MCS, a low-density parity check (LDPC) base graph, or a maximum number of permitted HARQ retransmissions; selecting, based at least in part on the retransmission step size, a starting point for rate matching of one or more coded bits in a buffer associated with a HARQ retransmission; and communicating the HARQ retransmission using the starting point for rate matching of the one or more coded bits.
Aspect 2: The method of Aspect 1, wherein the retransmission step size is in accordance with a combination of two or more of the code rate of the MCS, the LDPC base graph, or the maximum number of permitted HARQ retransmissions.
Aspect 3: The method of any of Aspects 1-2, wherein the maximum number of permitted HARQ retransmissions is signaled using a dedicated field included in a downlink grant for physical downlink shared channel communications or in an uplink grant for physical uplink shared channel communications.
Aspect 4: The method of any of Aspects 1-3, wherein the maximum number of permitted HARQ retransmissions is signaled using a radio resource control message.
Aspect 5: The method of any of Aspects 1-4, wherein the retransmission step size is identified in accordance with a mapping from at least one of the code rate of the MCS, the LDPC base graph, or the maximum number of permitted HARQ retransmissions to the step size.
Aspect 6: The method of Aspect 5, wherein the mapping from at least one of the code rate of the MCS, the LDPC base graph, or the maximum number of permitted HARQ retransmissions to the step size is configured via a mapping table indicated in a radio resource control message.
Aspect 7: The method of any of Aspects 1-6, wherein the retransmission step size is identified for one or more HARQ retransmissions associated with a downlink communication from a network node to the UE.
Aspect 8: The method of any of Aspects 1-7, wherein the retransmission step size is identified for one or more HARQ retransmissions associated with an uplink communication from the UE to a network node.
Aspect 9: The method of any of Aspects 1-8, wherein the retransmission step size is a same step size for all HARQ retransmissions associated with a communication.
Aspect 10: The method of any of Aspects 1-9, wherein identifying the retransmission step size comprises identifying at least a first retransmission step size for a HARQ retransmission associated with a communication and a second retransmission step size for another HARQ retransmission associated with the communication.
Aspect 11: The method of Aspect 10, wherein the HARQ retransmission is one or more initial HARQ retransmissions and the other HARQ retransmission is one or more subsequent HARQ retransmissions, wherein the first retransmission step size is shorter than the second retransmission step size.
Aspect 12: The method of Aspect 10, wherein the first retransmission step size is indicated in a redundancy version identifier associated with the HARQ retransmission and the second retransmission step size is indicated in another redundancy version identifier associated with the other HARQ retransmission.
Aspect 13: The method of Aspect 10, wherein the retransmission step size is in accordance with a redundancy version identifier and at least one of the code rate of the MCS, the LDPC base graph, or the maximum number of permitted HARQ retransmissions.
Aspect 14: The method of Aspect 10, wherein a mapping indicated in a radio resource control message maps at least one of a redundancy version identifier, the code rate of the MCS, the LDPC base graph, or the maximum number of permitted HARQ retransmissions to the retransmission step size.
Aspect 15: A method of wireless communication performed by a network node, comprising: transmitting configuration information regarding a retransmission step size for hybrid automatic repeat request (HARQ) retransmissions using a reserved modulation and coding scheme (MCS) with continuous rate matching, wherein the retransmission step size is in accordance with at least one of a code rate of the MCS, a low-density parity check (LDPC) base graph, or a maximum number of permitted HARQ retransmissions; and communicating the HARQ retransmission to a user equipment (UE) using the retransmission step size.
Aspect 16: The method of Aspect 15, wherein the retransmission step size is in accordance with a combination of two or more of the code rate of the MCS, the LDPC base graph, or the maximum number of permitted HARQ retransmissions.
Aspect 17: The method of any of Aspects 15-16, wherein the maximum number of permitted HARQ retransmissions is signaled to the UE using a dedicated field included in a downlink grant for physical downlink shared channel communications or in an uplink grant for physical uplink shared channel communications.
Aspect 18: The method of any of Aspects 15-17, wherein the maximum number of permitted HARQ retransmissions is signaled using a radio resource control message.
Aspect 19: The method of any of Aspects 15-18, wherein the retransmission step size is identified in accordance with a mapping from at least one of the code rate of the MCS, the LDPC base graph, or the maximum number of permitted HARQ retransmissions to the step size.
Aspect 20: The method of Aspect 19, wherein the mapping from at least one of the code rate of the MCS, the LDPC base graph, or the maximum number of permitted HARQ retransmissions to the step size is configured via a mapping table indicated in a radio resource control message.
Aspect 21: The method of any of Aspects 15-20, wherein the retransmission step size is identified for one or more HARQ retransmissions associated with a downlink communication from the network node to the UE.
Aspect 22: The method of any of Aspects 15-21, wherein the retransmission step size is identified for one or more HARQ retransmissions associated with an uplink communication from the UE to the network node.
Aspect 23: The method of any of Aspects 15-22, wherein the retransmission step size is a same step size for all HARQ retransmissions associated with a communication.
Aspect 24: The method of any of Aspects 15-23, wherein retransmission step size comprises at least a first retransmission step size for a HARQ retransmission associated with a communication and a second retransmission step size for another HARQ retransmission associated with the communication.
Aspect 25: The method of Aspect 24, wherein the HARQ retransmission is one or more initial HARQ retransmissions and the other HARQ retransmission is one or more subsequent HARQ retransmissions, wherein the first retransmission step size is shorter than the second retransmission step size.
Aspect 26: The method of Aspect 24, wherein the first retransmission step size is indicated in a redundancy version identifier associated with the HARQ retransmission and the second retransmission step size is indicated in another redundancy version identifier associated with the other HARQ retransmission.
Aspect 27: The method of Aspect 24, wherein the retransmission step size is in accordance with a redundancy version identifier and at least one of the code rate of the MCS, the LDPC base graph, or the maximum number of permitted HARQ retransmissions.
Aspect 28: The method of Aspect 24, wherein a mapping indicated in a radio resource control message maps at least one of a redundancy version identifier, the code rate of the MCS, the LDPC base graph, or the maximum number of permitted HARQ retransmissions to the retransmission step size.
Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.
Aspect 30: An apparatus for wireless communication at a device, the apparatus comprising one or more memories and one or more processors coupled to the one or more memories, the one or more processors configured to cause the device to perform the method of one or more of Aspects 1-28.
Aspect 31: An apparatus for wireless communication, the apparatus comprising at least one means for performing the method of one or more of Aspects 1-28.
Aspect 32: A non-transitory computer-readable medium storing code for wireless communication, the code comprising instructions executable by one or more processors to perform the method of one or more of Aspects 1-28.
Aspect 33: A non-transitory computer-readable medium storing a set of instructions for wireless communication, the set of instructions comprising one or more instructions that, when executed by one or more processors of a device, cause the device to perform the method of one or more of Aspects 1-28.
Aspect 34: A device for wireless communication, the device comprising a processing system that includes one or more processors and one or more memories coupled with the one or more processors, the processing system configured to cause the device to perform the method of one or more of Aspects 1-28.
Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.
Aspect 36: A device comprising a processing system that includes one or more processors and one or more code-storing memories coupled with the one or more processors, the processing system configured to cause the device to perform the method of one or more of Aspects 1-28.
Aspect 37: A device comprising a processing system that includes processor circuitry and code-storing memory circuitry, the processing system configured to cause the device to perform the method of one or more of Aspects 1-28.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, the one or more processors, individually or collectively and based at least in part on information stored in the one or more memories, being configured to:
identify a retransmission step size for hybrid automatic repeat request (HARQ) retransmissions using a reserved modulation and coding scheme (MCS) with continuous rate matching, wherein the retransmission step size is in accordance with at least one of a code rate of the MCS, a low-density parity check (LDPC) base graph, or a maximum number of permitted HARQ retransmissions;
select, based at least in part on the retransmission step size, a starting point for rate matching of one or more coded bits in a buffer associated with a HARQ retransmission; and
communicate the HARQ retransmission using the starting point for rate matching of the one or more coded bits.

2. The apparatus of claim 1, wherein the retransmission step size is in accordance with a combination of two or more of the code rate of the MCS, the LDPC base graph, or the maximum number of permitted HARQ retransmissions.

3. The apparatus of claim 1, wherein the maximum number of permitted HARQ retransmissions is signaled using a dedicated field included in a downlink grant for physical downlink shared channel communications or in an uplink grant for physical uplink shared channel communications.

4. The apparatus of claim 1, wherein the maximum number of permitted HARQ retransmissions is signaled using a radio resource control message.

5. The apparatus of claim 1, wherein the retransmission step size is identified in accordance with a mapping from at least one of the code rate of the MCS, the LDPC base graph, or the maximum number of permitted HARQ retransmissions to the step size.

6. The apparatus of claim 5, wherein the mapping from at least one of the code rate of the MCS, the LDPC base graph, or the maximum number of permitted HARQ retransmissions to the step size is configured via a mapping table indicated in a radio resource control message.

7. The apparatus of claim 1, wherein the retransmission step size is identified for one or more HARQ retransmissions associated with a downlink communication from a network node to the UE.

8. The apparatus of claim 1, wherein the retransmission step size is identified for one or more HARQ retransmissions associated with an uplink communication from the UE to a network node.

9. The apparatus of claim 1, wherein the retransmission step size is a same step size for all HARQ retransmissions associated with a communication.

10. The apparatus of claim 1, wherein the one or more processors, to identify the retransmission step size, are configured to identify at least a first retransmission step size for a HARQ retransmission associated with a communication and a second retransmission step size for another HARQ retransmission associated with the communication.

11. The apparatus of claim 10, wherein the HARQ retransmission is one or more initial HARQ retransmissions and the other HARQ retransmission is one or more subsequent HARQ retransmissions, wherein the first retransmission step size is shorter than the second retransmission step size.

12. The apparatus of claim 10, wherein the first retransmission step size is indicated in a redundancy version identifier associated with the HARQ retransmission and the second retransmission step size is indicated in another redundancy version identifier associated with the other HARQ retransmission.

13. The apparatus of claim 10, wherein the retransmission step size is in accordance with a redundancy version identifier and at least one of the code rate of the MCS, the LDPC base graph, or the maximum number of permitted HARQ retransmissions.

14. The apparatus of claim 10, wherein a mapping indicated in a radio resource control message maps at least one of a redundancy version identifier, the code rate of the MCS, the LDPC base graph, or the maximum number of permitted HARQ retransmissions to the retransmission step size.

15. An apparatus for wireless communication at a network node, comprising:
one or more memories; and
one or more processors, the one or more processors, individually or collectively and based at least in part on information stored in the one or more memories, being configured to:
transmit configuration information regarding a retransmission step size for hybrid automatic repeat request (HARQ) retransmissions using a reserved modulation and coding scheme (MCS) with continuous rate matching, wherein the retransmission step size is in accordance with at least one of a code rate of the MCS, a low-density parity check (LDPC) base graph, or a maximum number of permitted HARQ retransmissions; and
communicate the HARQ retransmission to a user equipment (UE) using the retransmission step size.

16. The apparatus of claim 15, wherein the retransmission step size is in accordance with a combination of two or more of the code rate of the MCS, the LDPC base graph, or the maximum number of permitted HARQ retransmissions.

17. The apparatus of claim 15, wherein the maximum number of permitted HARQ retransmissions is signaled to the UE using a dedicated field included in a downlink grant for physical downlink shared channel communications or in an uplink grant for physical uplink shared channel communications.

18. The apparatus of claim 15, wherein the maximum number of permitted HARQ retransmissions is signaled using a radio resource control message.

19. The apparatus of claim 15, wherein the retransmission step size is identified in accordance with a mapping from at least one of the code rate of the MCS, the LDPC base graph, or the maximum number of permitted HARQ retransmissions to the step size.

20. A method of wireless communication performed by a user equipment (UE), comprising:
identifying a retransmission step size for hybrid automatic repeat request (HARQ) retransmissions using a reserved modulation and coding scheme (MCS) with continuous rate matching, wherein the retransmission step size is in accordance with at least one of a code rate of the MCS, a low-density parity check (LDPC) base graph, or a maximum number of permitted HARQ retransmissions;
selecting, based at least in part on the retransmission step size, a starting point for rate matching of one or more coded bits in a buffer associated with a HARQ retransmission; and
communicating the HARQ retransmission using the starting point for rate matching of the one or more coded bits.
